(19) United States
(12) Patent Application Publication
(10) Pub. No.: US 2006/0109991 A1
(43) Pub. Date: May 25, 2006

(54) Audio/video playback system

(75) Inventor: Takenori Kaneko, Hyogo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignees: SANYO ELECTRIC CO., LTD., Moriguchi-shi (JP); SANYO TECHNOSOUND CO., LTD., Daito-shi (JP)

(21) Appl. No.: 11/285,011

(22) Filed: Nov. 23, 2005

(30) Foreign Application Priority Data
Nov. 25, 2004 (JP) 2004-339838

(51) Int. Cl. H04R 5/02

(52) U.S. Cl. 381/300

(57) ABSTRACT

An AV playback system of the present invention is configured by connecting an AV playback output device and a speaker driving device to each other by a cable. The AV playback output device includes a playback device and a cable connector. The connector includes a video output terminal, an audio output terminal, and a power input terminal for supplying power to the playback device. The speaker driving device includes audio external output terminals, a video external output terminal, a power external input terminal, and a cable connector. The connector includes a video input terminal for feeding the video signal to the video external output terminal, an audio input terminal for feeding the audio signal to the audio external output terminals, and a power output terminal for outputting power from the power external input terminal.

The priority application Number 2004-339838 upon which this patent application is based is hereby incorporated by reference.

### BACKGROUND OF THE INVENTION

1. Field of the Invention

The present invention relates to an audio/video playback system in which one or more audio signals output from an audio/video playback output device are fed to one or more speakers through a speaker driving device.

2. Description of Related Art

A 5.1-channel home theater system as shown in FIG. 3 has been conventionally known. The home theater system has arranged therein a center speaker 61 on a monitor device 51 installed on a monitor installation stand 5, a front-left channel speaker 62 and front-right channel speaker 63 on the left and right of the monitor device 51, and a rear-left channel speaker 64 and rear-right channel speaker 65 on the rear left and right of a viewer. Also arranged in the vicinity of the monitor device 51 are an audio/video (AV) playback output device 7 incorporating a DVD playback device (not shown) and a speaker driving device 8 incorporating a subwoofer speaker (not shown). Power plugs (both not shown) of power cords 770, 850 extending from the AV playback output device 7 and speaker driving device 8, respectively, are plugged into an AC power source 100.

In the above-described home theater system, video signals output from the AV playback output device 7 are fed through a video cable 510 to the monitor device 51 to display video on a screen of the monitor device 51. On the other hand, audio signals output from the AV playback output device 7 are fed through a system cable 9 to the speaker driving device 8 to output audio from the incorporated subwoofer speaker. The audio signals fed to the speaker driving device 8 are further fed through audio cables 610, 620, 630, 640, 650 to the above-described five speakers 61, 62, 63, 64, 65 to output audio from these speakers.

FIG. 4 illustrates a specific configuration of the above-described AV playback output device 7 and speaker driving device 8. The AV playback output device 7 is provided with a monitor connection terminal 75 for connecting the monitor device 51 through the video cable 510, an audio external input terminal 76 for connecting an external audio device 52 such as a CD player through an audio cable 520, and a power cord connection terminal 77 for connecting the power cord 770 having a power plug 771. Also provided is a cable connector 70 for connecting the system cable 9. The connector 70 includes an audio output terminal 701 and a control output terminal 702.

The AV playback output device 7 includes a DVD playback device 71, a preamp circuit 72, a microcomputer 73, and a power source circuit 74. Power from the AC power source (not shown) is supplied through the power cord 770, the power cord connection terminal 77, and a first power supply line 740 to the power source circuit 74, and further supplied through second to fourth power supply lines 741, 742, 743 to the DVD playback device 71, the preamp circuit 72, and the microcomputer 73. This causes the DVD playback device 71, the preamp circuit 72, and the microcomputer 73 to be in an operational state.

Control signals are fed from the microcomputer 73 through a first control signal line 731 and a second control signal line 732 to the DVD playback device 71 and the preamp circuit 72 to control operations of the DVD playback device 71 and the preamp circuit 72. Control signals are also fed from the microcomputer 73 through a third control signal line 733 to the control output terminal 702 of the cable connector 70.

Video signals reproduced by the DVD playback device 71 are output through a video signal line 78 from the monitor connection terminal 75 to the monitor device 51. On the other hand, audio signals reproduced by the DVD playback device 71 are fed through a first audio signal line 761 to the preamp circuit 72. Audio signals obtained from the external audio device 52 are also fed through the audio cable 520, the audio external input terminal 76, and a second audio signal line 762 to the preamp circuit 72.

The preamp circuit 72 includes a switch 720 capable of selecting either the first audio signal line or the second audio signal line and an amplifier circuit 721 for amplifying the audio signals. With the switch 720 selecting the first audio signal line, the audio signals reproduced by the DVD playback device 71 are fed to the amplifier circuit 721 and amplified, while with the switch 720 selecting the second audio signal line, the audio signals obtained from the external audio device 52 are fed to the amplifier circuit 721 and amplified. The audio signals amplified by the amplifier circuit 721 are fed through a third audio signal line 763 to the audio output terminal 701 of the cable connector 70.

On the other hand, the speaker driving device 8 is provided with five speaker connection terminals 841, 842, 843, 844, 845 for connecting the five speakers 61, 62, 63, 64, 65 through the above-mentioned audio cables 610, 620, 630, 640, 650 and a power cord connection terminal 85 for connecting the power cord 850 having a power plug 851. Also provided is a cable connector 80 for connecting the system cable 9. The connector 80 includes an audio input terminal 801 and a control input terminal 802.

The speaker driving device 8 includes a power amp circuit 81, a subwoofer speaker 82, and a power source circuit 83. Power from the AC power source (not shown) is supplied through the power cord 850, the power cord connection terminal 85, and a first power supply line 870 to the power source circuit 83, and further supplied through a second power supply line 871 to the power amp circuit 81. This causes the power amp circuit 81 to be in an operational state.

The audio signals fed to the audio output terminal 701 from the preamp circuit 72 of the AV playback output device 7 as described above are fed through the system cable 9, the audio input terminal 801 and a first audio signal line 860 of the speaker driving device 8 to the power amp circuit 81, and amplified by the circuit 81. The amplified audio signals are output through second to sixth audio signal lines 861-865 from the above-mentioned five speaker connection terminals 841-845 to the five speakers 61-65, and also fed through a seventh audio signal line 866 to the subwoofer speaker 82.

The control signals fed to the control output terminal 702 from the microcomputer 73 of the AV playback output device 7 as described above are fed through the system cable 9, the control input terminal 802 and a control signal line 88 of the speaker driving device 8 to the power amp circuit 81. An operation of the power amp circuit 81 of the speaker driving device 8 is thus controlled by the microcomputer 73 of the AV playback output device 7.

It is desirable to place the above-described AV playback output device 7 in the viewer's hand in order to change DVDs. However, in the case of placing the AV playback output device 7 in the viewer's hand as shown in FIG. 5, the video cable 510, the system cable 9, and the power cord 770 extend, respectively, from the AV playback output device 7 to the monitor device 51, the speaker driving device 8, and the AC power source 100, possibly causing the viewer himself or a person around him to stumble over these cables or the cord. Accordingly, the AV playback output device 7 is placed conventionally in the vicinity of the monitor device 51, the speaker driving device 8, and the AC power source 100 as shown in FIG. 3, so that the viewer has to move to the AV playback output device 7 to change DVDs, causing a problem of trouble in changing DVDs.

### SUMMARY OF THE INVENTION

An object of the present invention is to provide an AV playback system having fewer cables extending from an AV playback output device than conventionally.

As a result of intensive research, the present inventor focused attention on the speaker driving device 8 arranged in the vicinity of the monitor device 51 and the AC power source 100 as shown in FIG. 3 to accomplish the present invention.

An AV playback system of the present invention is configured by connecting an AV playback output device and a speaker driving device for feeding one or more audio signals to one or more speakers and driving the speakers to each other by a cable.

The AV playback output device includes one or more signal reproduction circuits for reproducing an audio signal and/or a video signal and a cable connector for connecting the cable. The cable connector includes one or more audio output terminals for outputting the reproduced audio signal, one or more video output terminals for outputting the reproduced video signal, and one or more power input terminals for supplying input power to the one or more signal reproduction circuits. On the other hand, the speaker driving device includes one or more audio external output terminals, one or more video external output terminals, a power external input terminal for receiving power from a commercial power source, and a cable connector for connecting the cable. The cable connector includes one or more audio input terminals for feeding the input audio signal to the one or more audio external output terminals, one or more video input terminals for feeding the input video signal to the one or more video external output terminals, and one or more power output terminals for outputting power supplied from the power external input terminal.

The cable connects to each other the one or more audio output terminals of the AV playback output device and the one or more audio input terminals of the speaker driving device, the one or more video output terminals of the AV playback output device and the one or more video input terminals of the speaker driving device, and the one or more power output terminals of the speaker driving device and the one or more power input terminals of the AV playback output device.

In the above-described AV playback system of the present invention, one or more speakers, for example, are connected to the one or more audio external output terminals of the speaker driving device, while one or more monitor devices, for example, are connected to the one or more video external output terminals. The power external input terminal is connected to a commercial power source.

In the above-described AV playback system, the power input from the commercial power source into the power external input terminal of the speaker driving device is supplied through the power output terminal of the cable connector of the device, the cable, and the power input terminal of the cable connector of the AV playback output device to the signal reproduction circuit. This causes the signal reproduction circuit to be in an operational state. In this state, a video signal reproduced by the signal reproduction circuit of the AV playback output device is output through the video output terminal of the cable connector of the device, the cable, and the video input terminal of the cable connector of the speaker driving device from the video external output terminal to the monitor device. Consequently, video reproduced by the AV playback output device will be displayed on a screen of the monitor device. On the other hand, an audio signal reproduced by the signal reproduction circuit of the AV playback output device is output from the audio external output terminal to the speaker through the audio output terminal of the cable connector of the AV playback output device, the cable, and the audio input terminal of the cable connector of the speaker driving device. Consequently, audio reproduced by the AV playback output device will be output from the speaker.

In the above-described AV playback system of the present invention, the video external output terminal is provided in the speaker driving device, and therefore the video cable is connected to the speaker driving device, not connected to the AV playback output device. Moreover, the video signal reproduced by the signal reproduction circuit of the AV playback output device is fed to the speaker driving device through the cable feeding the audio signal from the AV playback output device to the speaker driving device, and therefore a special cable for feeding the video signal to the speaker driving device need not be newly connected to the AV playback output device. The AV playback output device is powered from the speaker driving device, and therefore a power cord to be connected to the commercial power source need not be connected to the AV playback output device. Moreover, power from the speaker driving device is supplied to the AV playback output device through the cable feeding the audio signal from the AV playback output device to the speaker driving device, and therefore a special cable for receiving power supply from the speaker driving device need not be newly connected to the AV playback output device. Thus, the number of cables extending from the AV playback output device decreases compared with that of the conventional AV playback system in which the video cable and the power cord are connected to the AV playback output device.

Specifically, the audio/video playback output device includes one or more amplifier circuits for amplifying the audio signal to be fed to the one or more audio output terminals of the cable connector of the device. The cable connector further includes one or more audio input terminals for feeding an input audio signal to the one or more amplifier circuits. On the other hand, the speaker driving device further includes one or more external device connection terminals, and the cable connector of the device includes one or more audio output terminals for outputting an audio signal fed from the one or more external device connection terminals. The one or more audio output terminals and the one or more audio input terminals of the audio/video playback output device are connected to each other by the cable.

In the AV playback system having the above-described specific configuration, one or more AV devices such as a CD player or a VTR are connected to the one or more external device connection terminals of the speaker driving device.

The audio signal input from the AV device into the external device connection terminal of the speaker driving device is fed through the audio output terminal of the cable connector of the device, the cable, and the audio input terminal of the cable connector of the AV playback output device to the amplifier circuit, and amplified by the circuit. The amplified audio signal is output through the audio output terminal of the cable connector of the AV playback output device, the cable, and the audio input terminal of the cable connector of the speaker driving device from the audio external output terminal to the speaker. Consequently, audio reproduced by the AV device will be output from the speaker.

In the AV playback system having the above-described specific configuration, the external device connection terminal is provided in the speaker driving device, and therefore the audio cable and the video cable are connected to the speaker driving device, not connected to the AV playback output device. Moreover, the audio signal input into the external device connection terminal of the speaker driving device is fed to the AV playback output device through the cable feeding the audio signal from the AV playback output device to the speaker driving device, and therefore a special cable for receiving the audio signal fed from the speaker driving device need not be newly connected to the AV playback output device. Thus, the number of cables extending from the AV playback output device further decreases.

As described above, according to the AV playback system of the present invention, the number of cables extending from the AV playback output device can be smaller than conventionally.

### BRIEF DESCRIPTION OF THE DRAWINGS

FIG. 1 is a perspective view showing an arrangement of each device included in a home theater system of the present invention;

FIG. 2 is a block diagram showing a specific configuration of an AV playback output device and a speaker driving device included in the above home theater system;

FIG. 3 is a perspective view showing an arrangement of each device included in a conventional home theater system;

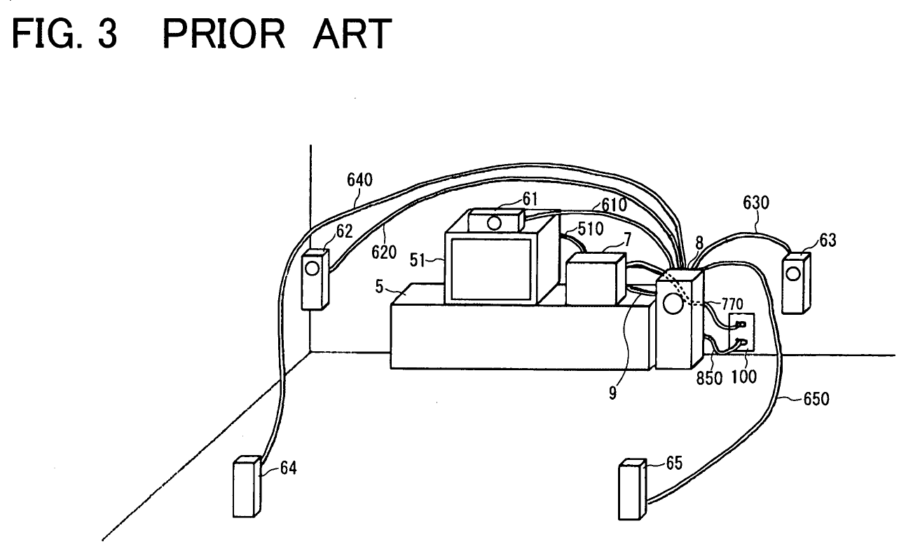

FIG. 4 is a block diagram showing a specific configuration of an AV playback output device and a speaker driving device included in the above home theater system; and

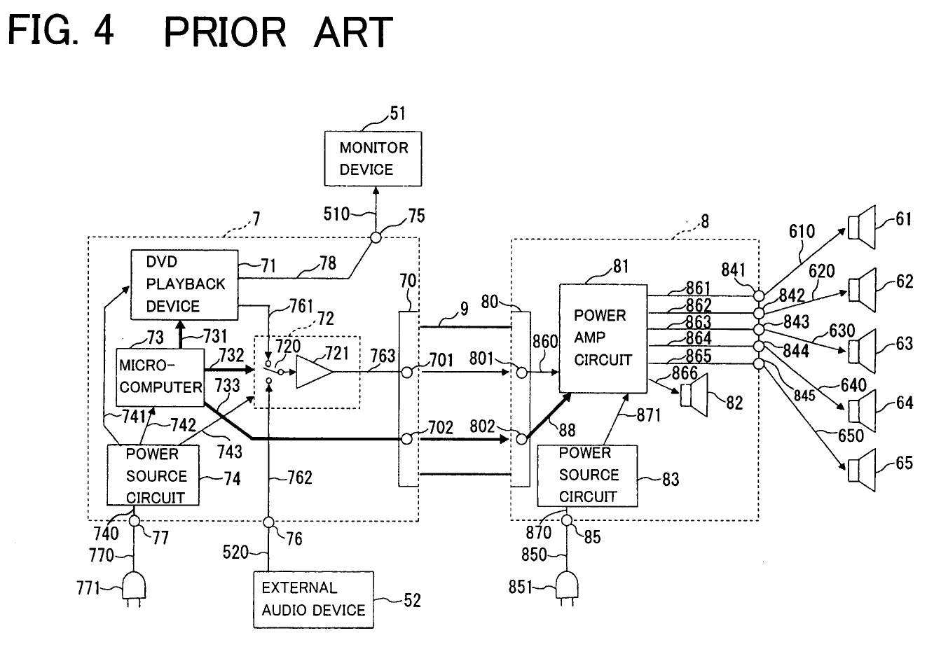

FIG. 5 is a perspective view showing another arrangement of each device included in the above home theater system.

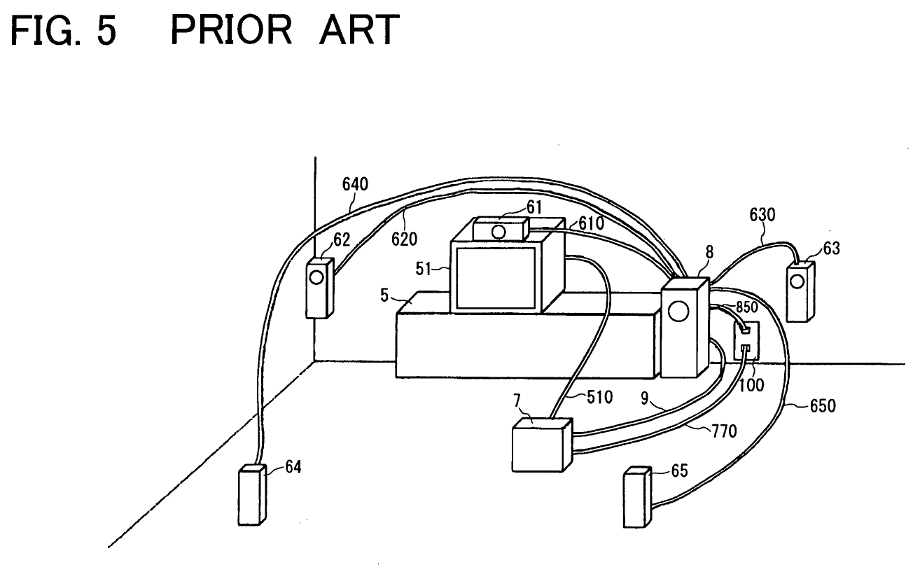

### DETAILED DESCRIPTION OF THE INVENTION

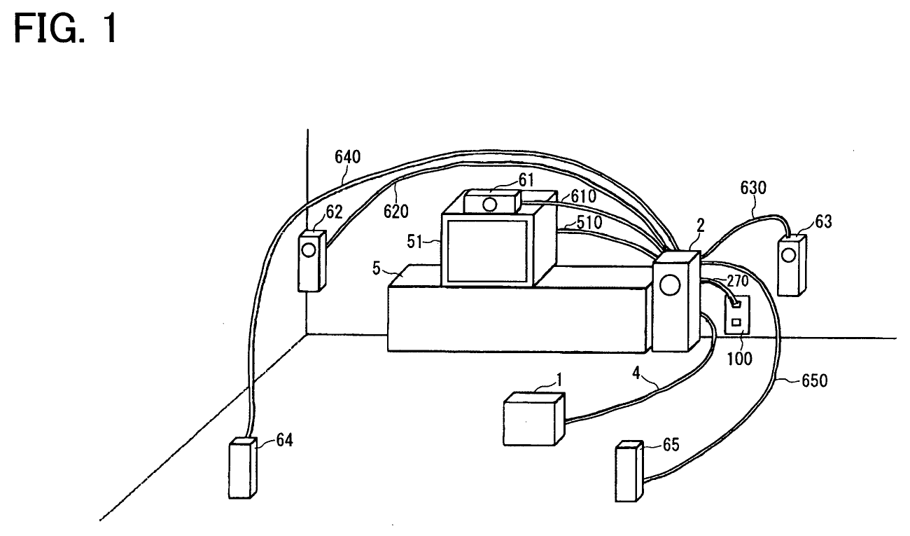

An example of the present invention carried out in a home theater system shown in FIG. 1 will be specifically described below with reference to the drawings.

The home theater system of the present invention has arranged therein a center speaker 61 on a monitor device 51 installed on a monitor installation stand 5, a front-left channel speaker 62 and front-right channel speaker 63 on the left and right of the monitor device 51, and a rear-left channel speaker 64 and rear-right channel speaker 65 on the rear left and right of a viewer. A speaker driving device 2 incorporating a subwoofer speaker (not shown) is arranged in the vicinity of the monitor device 51. A power plug (not shown) of a power cord 270 extending from the speaker driving device 2 is plugged into an AC power source 100. An AV playback output device 1 incorporating a DVD playback device (not shown) is also arranged in the viewer's hand.

In the above-described home theater system, video signals output from the AV playback output device 1 are fed through a system cable 4 to the speaker driving device 2, and thereafter further fed through a video cable 510 to the monitor device 51 to display video on a screen of the monitor device 51. On the other hand, audio signals output from the AV playback output device 1 are fed through the system cable 4 to the speaker driving device 2 to output audio from the incorporated subwoofer speaker. The audio signals fed to the speaker driving device 2 are further fed through audio cables 610, 620, 630, 640, 650 to the above-described five speakers 61, 62, 63, 64, 65 to output audio from these speakers.

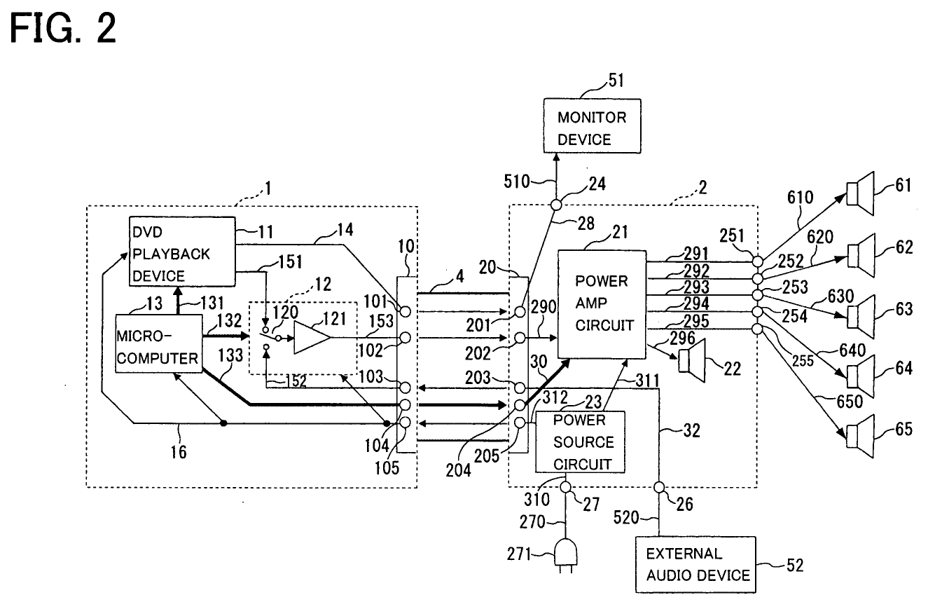

FIG. 2 illustrates a specific configuration of the above-described AV playback output device 1 and speaker driving device 2. The AV playback output device 1 is provided with a cable connector 10 for connecting the system cable 4. The connector 10 includes a video output terminal 101, an audio output terminal 102, an audio input terminal 103, a control output terminal 104, and a power input terminal 105.

The AV playback output device 1 includes a DVD playback device 11, a preamp circuit 12, and a microcomputer 13. Power input from the speaker driving device 2 into the power input terminal 105 of the cable connector 10 as described below is supplied through a power supply line 16 to the DVD playback device 11, the preamp circuit 12, and the microcomputer 13. This causes the DVD playback device 11, the preamp circuit 12, and the microcomputer 13 to be in an operational state.

Control signals are fed from the microcomputer 13 through a first control signal line 131 and a second control signal line 132 to the DVD playback device 11 and the preamp circuit 12 to control operations of the DVD playback device 11 and the preamp circuit 12. Control signals are also fed from the microcomputer 13 through a third control signal line 133 to the control output terminal 104 of the cable connector 10.

Video signals reproduced by the DVD playback device 11 are fed through a video signal line 14 to the video output terminal 101 of the cable connector 10. On the other hand, audio signals reproduced by the DVD playback device 11 are fed through a first audio signal line 151 to the preamp circuit 12. Audio signals input from an external audio device 52 through the speaker driving device 2 into the audio input terminal 103 as described below are also fed through a second audio signal line 152 to the preamp circuit 12.

The preamp circuit 12 includes a switch 120 capable of selecting either the first audio signal line or the second audio signal line and an amplifier circuit 121 for amplifying the audio signals. With the switch 120 selecting the first audio signal line, the audio signals reproduced by the DVD playback device 11 are fed to the amplifier circuit 121 and amplified, while with the switch 120 selecting the second audio signal line, the audio signals obtained from the external audio device 52 are fed to the amplifier circuit 121 and amplified. The audio signals amplified by the amplifier circuit 121 are fed through a third audio signal line 153 to the audio output terminal 102 of the cable connector 10.

On the other hand, the speaker driving device 2 is provided with five speaker connection terminals 251, 252, 253, 254, 255 for connecting the five speakers 61, 62, 63, 64, 65 through the above-mentioned audio cables 610, 620, 630, 640, 650, a monitor connection terminal 24 for connecting the monitor device 51 through the above-mentioned video cable 510, an audio external input terminal 26 for connecting an external audio device 52 such as a CD player through an audio cable 520, and a power cord connection terminal 27 for connecting the power cord 270 having a power plug 271. Also provided is a cable connector 20 for connecting the system cable 4. The connector 20 includes a video input terminal 201, an audio input terminal 202, an audio output terminal 203, a control input terminal 204, and a power output terminal 205.

The speaker driving device 2 includes a power amp circuit 21, a subwoofer speaker 22, and a power source circuit 23. Power from the AC power source (not shown) is supplied through the power cord 270, the power cord connection terminal 27, and a first power supply line 310 to the power source circuit 23, and further supplied through a second power supply line 311 to the power amp circuit 21. This causes the power amp circuit 21 to be in an operational state. The power supplied to the power source circuit 23 is input through a third power supply line 312, the power output terminal 205 of the cable connector 20, and the system cable 4 into the power input terminal 105 of the AV playback output device 1, and thereafter supplied to the DVD playback device 11, the preamp circuit 12, and the microcomputer 13 as described above.

Audio signals input from the external audio device 52 through the audio cable 520 into the audio external input terminal 26 is input through an external audio signal line 32, the audio output terminal 203 of the cable connector 20, and the system cable 4 into the audio input terminal 103 of the AV playback output device 1, and thereafter fed to the preamp circuit 12 as described above. The audio signals obtained from the external audio device 52 are thus fed through the speaker driving device 2 and the system cable 4 to the preamp circuit 12 of the AV playback output device 1.

The video signals fed to the video output terminal 101 from the DVD playback device 11 of the AV playback output device 1 as described above is output through the system cable 4, the video input terminal 201 and a video signal line 28 of the speaker driving device 2 from the monitor connection terminal 24 to the monitor device 51. The video signals reproduced by the AV playback output device 1 are thus fed through the speaker driving device 2 to the monitor device 51.

On the other hand, the audio signals fed to the audio output terminal 102 from the preamp circuit 12 of the AV playback output device 1 as described above are fed through the system cable 4, the audio input terminal 202 and a first audio signal line 290 of the speaker driving device 2 to the power amp circuit 21, and amplified by the circuit 21. The amplified audio signals are output through second to sixth audio signal lines 291-295 from the above-mentioned five speaker connection terminals 251-255 to the five speakers 61-65, and also fed through a seventh audio signal line 296 to the subwoofer speaker 22. The audio signals reproduced by the AV playback output device 1 or audio signals fed to the AV playback output device 1 from the external audio device 52 as described above are thus fed through the system cable 4 to the speaker driving device 2, and further fed through the five audio cables 610, 620, 630, 640, 650 to the five speakers 61-65.

The control signals fed to the control output terminal 104 from the microcomputer 13 of the AV playback output device 1 as described above are fed through the system cable 4, the control input terminal 204 and a control signal line 30 of the speaker driving device 2 to the power amp circuit 21. An operation of the power amp circuit 21 of the speaker driving device 2 is thus controlled by the microcomputer 13 of the AV playback output device 1.

In the home theater system of the present invention, as shown in FIG. 2, the monitor connection terminal 24 and the audio external input terminal 26 are provided in the speaker driving device 2, and therefore the video cable and the audio cable are connected to the speaker driving device 2, not connected to the AV playback output device 1. Moreover, the video signals reproduced by the DVD playback device 11 of the AV playback output device 1 are fed to the speaker driving device 2 through the system cable 4 feeding the audio signals from the AV playback output device 1 to the speaker driving device 2, while the audio signals input into the audio external input terminal 26 of the speaker driving device 2 are fed to the AV playback output device 1 through the system cable 4, and therefore a special cable for feeding the video signals to the speaker driving device 2 and a special cable for receiving the audio signals fed from the speaker driving device 2 need not be newly connected to the AV playback output device 1.

The AV playback output device 1 is powered from the speaker driving device 2, and therefore a power cord to be connected to the commercial power source need not be connected to the AV playback output device 1. Moreover, the power from the speaker driving device 2 is supplied to the AV playback output device 1 through the above-described system cable 4, and therefore a special cable for receiving power supply from the speaker driving device 2 need not be newly connected to the AV playback output device 1.

Thus, it is only the single system cable 4 that extends from the AV playback output device 1 as shown in FIG. 1, so that a possibility for the viewer himself or a person around him to stumble over the system cable 4 is extremely low even in the case of placing the AV playback output device 1 in the viewer's hand.

Furthermore, a power source circuit may be omitted from the AV playback output device 1, and therefore the AV playback output device 1 becomes compact with a reduced cost.

The above description of an embodiment is intended to describe the present invention, and should not be understood to limit the invention set forth in the claims or restrict the scope thereof. The present invention is not limited to the foregoing embodiment in construction but can of course be modified variously without departing from the spirit of the present invention as set forth in the appended claims.

For example, a plurality of monitor connection terminals 24 or a plurality of audio external input terminals 26 may be provided in the speaker driving device 2 shown in FIG. 2.

The audio external input terminal 26 is provided as an external device connection terminal, but an AV external input terminal for connecting an AV device such as a VTR may be provided to feed audio signals input into the input terminal to the audio output terminal 203 of the cable connector 20, and to feed video signals input into the input terminal to the monitor connection terminal 24.

Further, a configuration may be used in which a plurality of power amp circuits 21 of the same number as speakers are provided in the speaker driving device 2. In the configuration, for example, a plurality of control output terminals 104 are provided in the cable connector 10 of the AV playback output device 1, while a plurality of control input terminals 204 are provided in the cable connector 20 of the speaker driving device 2.

What is claimed is:

1. An audio/video playback system comprising an audio/video playback output device, a speaker driving device for feeding one or more audio signals to one or more speakers and driving the speakers, and a cable connecting the devices to each other, the audio/video playback output device comprising one or more signal reproduction circuits for reproducing an audio signal and/or a video signal and a cable connector for connecting the cable, the cable connector comprising one or more audio output terminals for outputting the reproduced audio signal, one or more video output terminals for outputting the reproduced video signal, and one or more power input terminals for supplying input power to the one or more signal reproduction circuits, the speaker driving device comprising one or more audio external output terminals, one or more video external output terminals, a power external input terminal for receiving power from a commercial power source, and a cable connector for connecting the cable, the cable connector comprising one or more audio input terminals for feeding the input audio signal to the one or more audio external output terminals, one or more video input terminals for feeding the input video signal to the one or more video external output terminals, and one or more power output terminals for outputting the power supplied from the power external input terminal,
wherein the one or more audio output terminals of the audio/video playback output device and the one or more audio input terminals of the speaker driving device, the one or more video output terminals of the audio/video playback output device and the one or more video input terminals of the speaker driving device, and the one or more power output terminals of the speaker driving device and the one or more power input terminals of the audio/video playback output device are connected to each other by the cable.

2. The audio/video playback system according to claim 1, wherein the audio/video playback output device comprises one or more amplifier circuits for amplifying the audio signal to be fed to the one or more audio output terminals of the cable connector of the device, the cable connector further comprising one or more audio input terminals for feeding an input audio signal to the one or more amplifier circuits, the speaker driving device further comprising one or more external device connection terminals, the cable connector of the device comprising one or more audio output terminals for outputting an audio signal fed from the one or more external device connection terminals, the one or more audio output terminals and the one or more audio input terminals of the audio/video playback output device being connected to each other by the cable.

3. The audio/video playback system according to claim 2, wherein the speaker driving device further comprises one or more amplifier circuits for amplifying and feeding the audio signal input into the one or more audio input terminals of the cable connector of the device to the one or more audio external output terminals.

4. The audio/video playback system according to claim 3, wherein the audio/video playback output device further comprises a control circuit for controlling an operation of the one or more signal reproduction circuits, an operation of the one or more amplifier circuits of the device, and an operation of the one or more amplifier circuits of the speaker driving device, the cable connector of the audio/video playback output device further comprising one or more control output terminals for outputting a control signal from the control circuit, the cable connector of the speaker driving device further comprising one or more control input terminals for feeding the input control signal to the one or more amplifier circuits, the one or more control output terminals of the audio/video playback output device and the one or more control input terminals of the speaker driving device being connected to each other by the cable.

5. An audio/video playback output device capable of being connected by a cable to a speaker driving device for feeding one or more externally fed audio signals to one or more speakers and driving the speaker, the audio/video playback output device comprising one or more signal reproduction circuits for reproducing an audio signal and/or a video signal and a cable connector for connecting the cable, the cable connector comprising one or more audio output terminals for outputting the reproduced audio signal, one or more video output terminals for outputting the reproduced video signal, and one or more power input terminals for supplying input power to the one or more signal reproduction circuits.

6. A speaker driving device being connectable to an audio/video playback output device by a cable and feeding one or more audio signals fed from the audio/video playback output device to one or more speakers and driving the speakers, the speaker driving device comprising one or more audio external output terminals, one or more video external output terminals, a power external input terminal for receiving power from a commercial power source, and a cable connector for connecting the cable, the cable connector comprising one or more audio input terminals for feeding an input audio signal to the one or more audio external output terminals, one or more video input terminals for feeding an input video signal to the one or more video external output terminals, and one or more power output terminals for outputting the power supplied from the power external input terminal.
